(19) United States
(12) Patent Application Publication
(10) Pub. No.: US 2013/0157832 A1
(43) Pub. Date: Jun. 20, 2013

(54) ELONGATE STRUCTURES AND DEVICES AND METHODS FOR MANUFACTURING SAME

(71) Applicant: Jason S. Erdie, Richfield, OH (US)

(72) Inventor: Jason S. Erdie, Richfield, OH (US)

(21) Appl. No.: 13/765,482

(22) Filed: Feb. 12, 2013

Related U.S. Application Data
(63) Continuation-in-part of application No. PCT/US2011/039370, filed on Jun. 7, 2011.
Application No. PCT/US2011/039370 is a continuation-in-part of application No. 13/071,157, filed on Mar. 24, 2011.
Application No. 13/071,157 is a continuation of application No. PCT/US2010/058559, filed on Dec. 1, 2010.
(60) Provisional application No. 61/373,481, filed on Aug. 13, 2010.
(60) Provisional application No. 61/266,422, filed on Dec. 3, 2009.
(60) Provisional application No. 61/373,481, filed on Aug. 13, 2010.

(51) Int. Cl. B31F 1/00

(52) U.S. Cl. CPC B31F 1/0009
USPC 493/405

(57) ABSTRACT

A device for wrapping a substantially flat piece of sheet material with a plurality of creases that define fold lines that when folded, forms an elongate structure that includes a hollow outer portion and a hollow inner portion disposed within the hollow outer portion. The device includes a mandrel, a gripper blade that releasably secures the sheet material to the mandrel, a motor that rotates the mandrel when the sheet material is secured to the mandrel, and a compressive member that releasably presses the first outer side surface of the hollow outer portion of the elongate structure against the inner portion of the elongate structure after the sheet material has been wrapped about the mandrel. The device can also include a controller that is operably associated with the motor and the compressive member.

### CROSS-REFERENCE TO RELATED APPLICATIONS

This application is a continuation-in-part of PCT/US2011/039370, filed Jun. 7, 2011, which claims priority to U.S. App. Ser. No. 61/373,481, filed Aug. 13, 2010, and also a continuation-in-part of U.S. application Ser. No. 13/071,157, filed Mar. 24, 2011, which is a continuation of PCT/US2010/058559, filed Dec. 1, 2010, which claims priority to U.S. App. Ser. No. 61/266,422, filed Dec. 3, 2009 and U.S. App. Ser. No. 61/373,481, filed Aug. 13, 2010.

### BACKGROUND OF INVENTION

1. Field of the Invention

The present invention relates to an elongate structure with a reinforcement member and also to a device for folding a piece of sheet material into an elongate structure. The present invention also relates to a method for manufacturing elongate structures.

2. Description of Related Art

Due to increased fuel costs, there is renewed interest in ways to save energy during the transportation of goods. One way to accomplish this task is to reduce the overall weight of the material being shipped. Most material is shipped on a pallet. Weight reduction can be achieved by reducing the weight of the pallets upon which material is shipped.

A substantial majority of conventional pallets are made of wood, which provides sufficient strength to support extremely heavy loads. But a substantial percentage of material shipped on pallets is not extremely heavy. Furthermore, the creation of wooden pallets typically requires large and detailed machines that are kept offsite from the facility that is loading the packages onto the pallets. Thus, extra planning and manpower are required to ensure that adequate pallets are present at the loading facility when needed. Wooden pallets take up room, are easily broken and thus are frequently in need of repair.

Accordingly, it would be desirable to be able to fabricate pallets from materials other than wood. It would also be desirable for non-wooden pallets to be robust enough to support moderately heavy loads during shipping and for extended periods of time in a warehouse. Further still, it would be desirable for non-wooden pallets to be able to be fabricated onsite, near where the material to be shipped or stored is loaded onto the pallets. The present invention provides pallets that meet these goals.

### BRIEF SUMMARY OF THE INVENTION

In view of the foregoing, the present invention is directed to a device that wraps a substantially flat piece of sheet material provided with a plurality of creases that define fold lines about a mandrel to form an elongate structure. The elongate structure includes a hollow outer portion and a hollow inner portion disposed within the hollow outer portion. The hollow outer portion includes at least a first outer side surface that defines a first plane, a second outer side surface that defines a second plane, and a third outer side surface that defines a third plane. The first plane intersects with the second plane at a first dihedral angle. The second plane intersects with the third plane at a second dihedral angle. The third plane intersects with the first plane at a third dihedral angle. The sum of the first dihedral angle, the second dihedral angle, and the third dihedral angle is about 180°. The hollow inner portion contacts a first inner side of the hollow outer portion opposite the first outer side surface. A second inner side of the hollow outer portion is opposite the second outer side surface and a third side of the hollow outer portion is opposite the third outer side surface. The hollow inner portion includes at least a first panel that extends between the first inner side of the hollow outer portion and the second inner side of the hollow outer portion so as to define a first hollow inner triangular channel. A second panel extends between the second inner side of the hollow outer portion and the third inner side of the hollow outer portion so as to define a second hollow inner triangular channel. The device includes a mandrel, a gripper blade for releasably securing the sheet material to the mandrel, and a motor for rotating the mandrel when the sheet material is secured to the mandrel thereby wrapping the sheet material about the mandrel such that the sheet material folds at the fold lines and forms the elongate structure. The device also includes a compressive member for releasably pressing the first outer side surface of the hollow outer portion of the elongate structure against the inner portion of the elongate structure after the sheet material has been wrapped about the mandrel and formed into the elongate structure, and a controller operably associated with the motor and the compressive member. The controller is adapted to control the rotation of the mandrel and the pressure applied to the first outer side surface of the hollow outer portion.

The present invention also provides an elongate structure that includes a hollow outer portion formed of sheet material, a hollow inner portion formed of sheet material, and a separate and distinct U-shaped reinforcement portion formed of sheet material that is disposed within the hollow inner portion. The hollow outer portion includes at least a first outer side surface that defines a first plane, a second outer side surface that defines a second plane, and a third outer side surface that defines a third plane. The first plane intersects with the second plane at a first dihedral angle and the second plane intersects with the third plane at a second dihedral angle. Further, the third plane intersects with the first plane at a third dihedral angle. The sum of the first dihedral angle, the second dihedral angle, and the third dihedral angle is about 180°. The hollow inner portion is disposed within the hollow outer portion. The hollow inner portion contacts a first inner side of the hollow outer portion opposite the first outer side surface. A second inner side surface of the hollow outer portion is opposite the second outer side surface. A third inner side surface of the hollow outer portion is opposite the third outer side surface. The hollow inner portion includes at least a first panel that extends between the first inner side of the hollow outer portion and the second inner side of the hollow outer portion so as to define a first hollow inner triangular channel. A second panel extends between the second inner side of the hollow outer portion and the third inner side of the hollow outer portion so as to define a second hollow inner triangular channel. The U-shaped reinforcement portion, which is disposed within the hollow inner portion, increases the beam strength of the elongate structure without substantially increasing the weight of the structure.

The present invention also provides a method for manufacturing elongate structures. The method of the invention includes providing a substantially flat piece of sheet material provided with a plurality of creases that define fold lines that, when the sheet material is folded thereon, form an elongate structure that includes a hollow outer portion and a hollow inner portion disposed within the hollow outer portion. The hollow outer portion includes at least a first outer side surface that defines a first plane, a second outer side surface that defines a second plane, and a third outer side surface that defines a third plane. The first plane intersects with the second plane at a first dihedral angle, and the second plane intersects with the third plane at a second dihedral angle. The third plane intersects with the first plane at a third dihedral angle. The sum of the first dihedral angle, the second dihedral angle, and the third dihedral angle is about 180°. The hollow inner portion contacts a first inner side of the hollow outer portion that is opposite the first outer side surface. A second inner side of the hollow outer portion is opposite the second outer side surface. A third inner side of the hollow outer portion is opposite the third outer side surface. The hollow inner portion includes at least a first panel that extends between the first inner side of the hollow outer portion and the second inner side of the hollow outer portion so as to define a first hollow inner triangular channel. A second panel extends between the second inner side of the hollow outer portion and the third inner side of the hollow outer portion so as to define a second hollow inner triangular channel. In accordance with the method, a leading edge of the sheet material is releasably secured to a mandrel, the mandrel is rotated in a first direction to wrap the sheet material about the mandrel, causing it to fold on the fold lines and thereby form the elongate structure. A compressive member compresses the folded sheet material to the mandrel.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 shows a top view of an exemplary embodiment of a substantially flat piece of sheet material provided with a plurality of creases that define fold lines, which can be rolled/folded to form an elongate structure (sometimes herein referred to as a completely unassembled elongate structure).

FIG. 2 shows the substantially flat piece of sheet material from FIG. 1 being rolled/folded into an elongate structure.

FIG. 3 shows an end perspective view of the substantially flat piece of sheet material from FIG. 1 being further rolled/folded into an elongate structure and a U-shaped member to one side.

FIG. 4 shows the substantially flat piece of sheet material from FIG. 1 after it has been rolled/folded into a fully assembled elongate structure and a U-shaped member has been inserted into the inner portion.

FIG. 5 shows a top view of another exemplary embodiment of a substantially flat piece of sheet material provided with a plurality of creases that define fold lines, which can be rolled/folded to form an elongate structure.

FIG. 6 shows a fully assembled elongate structure formed from the substantially flat piece of sheet material shown in FIG. 5 with end flaps in a closed position.

FIG. 7 shows an exemplary elongate structure having an outer portion that has a trapezoidal-shaped cross-section.

FIG. 8 shows a pallet incorporating elongate structures as shown in FIG. 4 as pallet runners.

FIG. 9 shows a pallet incorporating elongate structures as shown in FIG. 7 in an inverted orientation.

FIG. 10 shows the pallet shown in FIG. 9 in an upright orientation.

FIG. 11 shows another embodiment of a pallet according to the invention incorporating elongate structures as shown in FIG. 4 as pallet runners.

FIG. 12 is a top perspective view of an exemplary device according to the invention.

FIG. 13 is a top perspective view of the device shown in FIG. 12 with the table removed to allow viewing of the components beneath the table.

FIG. 14 is a section view taken through a portion of a device according to the invention and an elongate structure formed thereon.

FIG. 15 is a perspective view of another exemplary embodiment of a device according to the invention.

FIG. 16 is a section view of a portion of the device shown in FIG. 15 in a first position.

FIG. 17 is a section view of the device shown in FIG. 16 in a second position.

FIG. 18 is a section view of the device shown in FIG. 16 in a third position.

FIG. 19 is a section view of the device shown in FIG. 16 after formation of an elongate structure in a fourth position.

FIG. 20 is a flowchart illustrating a method for manufacturing an elongate structure.

### DETAILED DESCRIPTION OF THE INVENTION

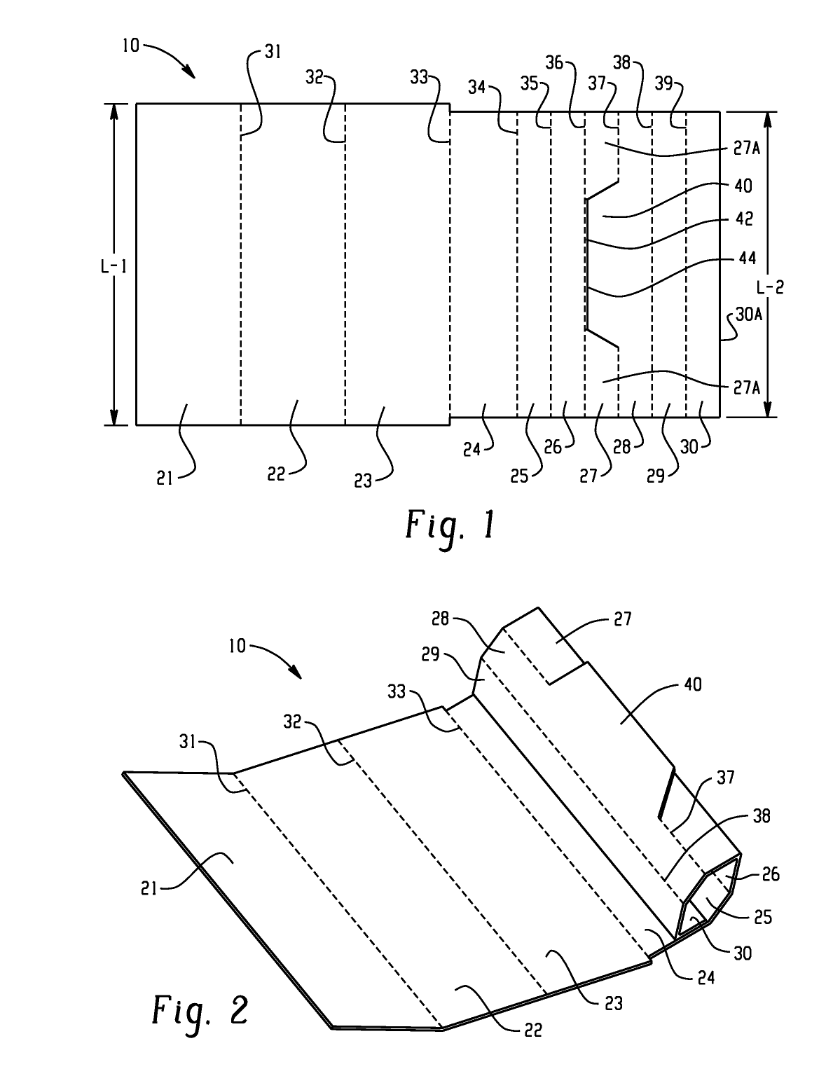

Referring now to the drawings, FIGS. 1-4 show an embodiment of an elongate structure 10 according to the invention. In the embodiment shown in FIGS. 1-4, when fully assembled, the elongate structure 10 includes a hollow outer portion 12, which in the illustrated embodiment is generally triangular shaped, and a hollow inner portion 14, which in the illustrated embodiment is generally hexagonal shaped. The hollow outer portion 12 and the hollow inner portion 14 are formed from multiple panels, as will be subsequently described. Further, the elongate structure 10 is adapted to be cut from a single sheet of corrugated cardboard or other type of sheet material.

FIG. 1 shows the sheet material before it has been rolled/folded into an elongate structure 10, which is sometimes referred to herein as a completely unassembled state. The sheet material includes a first panel 21, a second panel 22, a third panel 23, a fourth panel 24, a fifth panel 25, a sixth panel 26, a seventh panel 27, an eighth panel 28, a ninth panel 29, and a tenth panel 30. The first panel 21 is joined to the second panel 22 at a first fold-line 31. The second panel 22 is joined to the third panel 23 at a second fold-line 32. The third panel 23 is joined to the fourth panel 24 at a third fold line 33. The fourth panel 24 is joined to the fifth panel 25 at a fourth fold line 34. The fifth panel 25 is joined to the sixth panel 26 at a fifth fold line 35. The sixth panel 26 is joined to the seventh panel 27 at a sixth fold line 36. The seventh panel 27 is joined to the eighth panel 28 at a seventh fold line 37. The eighth panel 28 is joined to the ninth panel 29 at an eighth fold line 38. And, the ninth panel 29 is joined to the tenth panel 30 at a ninth fold line 39. Each fold line 31-39 is generally parallel to a longitudinal axis of the elongate structure 10 when fully assembled.

In the embodiment shown in FIG. 1, the seventh panel 27 is subdivided into two discontinuous regions 27A by an extension tab 40. The extension tab 40 extends from the eighth panel 28 toward the sixth fold line 36. It will be appreciated that the presence of extension tabs is not necessary, and that the number of extension tabs is not per se critical, and that zero, one or a plurality of extension tabs may be used. The extension tab 40 is formed by cutting through the sheet material along the perimeter of the extension tab 40 and not including a fold line between the extension tab 40 and the remainder of the eighth panel 28. Thus, the seventh fold line 37 is not present between the extension tab 40 and the eighth panel 28. As will be discussed in greater detail below, it is advantageous to remove a small portion of the sheet material so as to provide a space 42 between an edge 44 of the extension tab 40 and the sixth fold line 36.

In the embodiment of the invention shown in FIG. 1, the first panel 21, the second panel 22 and the third panel 23 have the same length L-1. Further, the fourth panel 24, the fifth panel 25, the sixth panel 26, the seventh panel 27, the eighth panel 28, the ninth panel 29 and the tenth panel 30 have the same length L-2. L-1 is preferably greater than L-2 so as to facilitate the insertion of an end cap (not shown).

FIG. 2 shows the elongate structure 10 in a partially-assembled state. In this configuration, the outer side of the tenth panel 30 has been adhered to the inner side of the fourth panel 24 such that an outside cut edge 30A of the tenth panel 30 is substantially aligned with the fourth fold line 34. This results in the formation of the hollow inner portion 14 having the hexagonal tubular structure whereby the sides of the hollow inner portion 14 are defined by the fifth panel 25, the sixth panel 26, the seventh panel 27, the eighth panel 28, the ninth panel 29 and the tenth panel 30. The elongate structure 10 can conveniently be provided to end-users in this partially-assembled condition. It will be appreciated, however, that it is not necessary to adhere the tenth panel 30 to the inner side of the fourth panel 24, and that an elongate structure can be formed by simply placing such panels into contact with each other at the commencement of the rolling/folding operation.

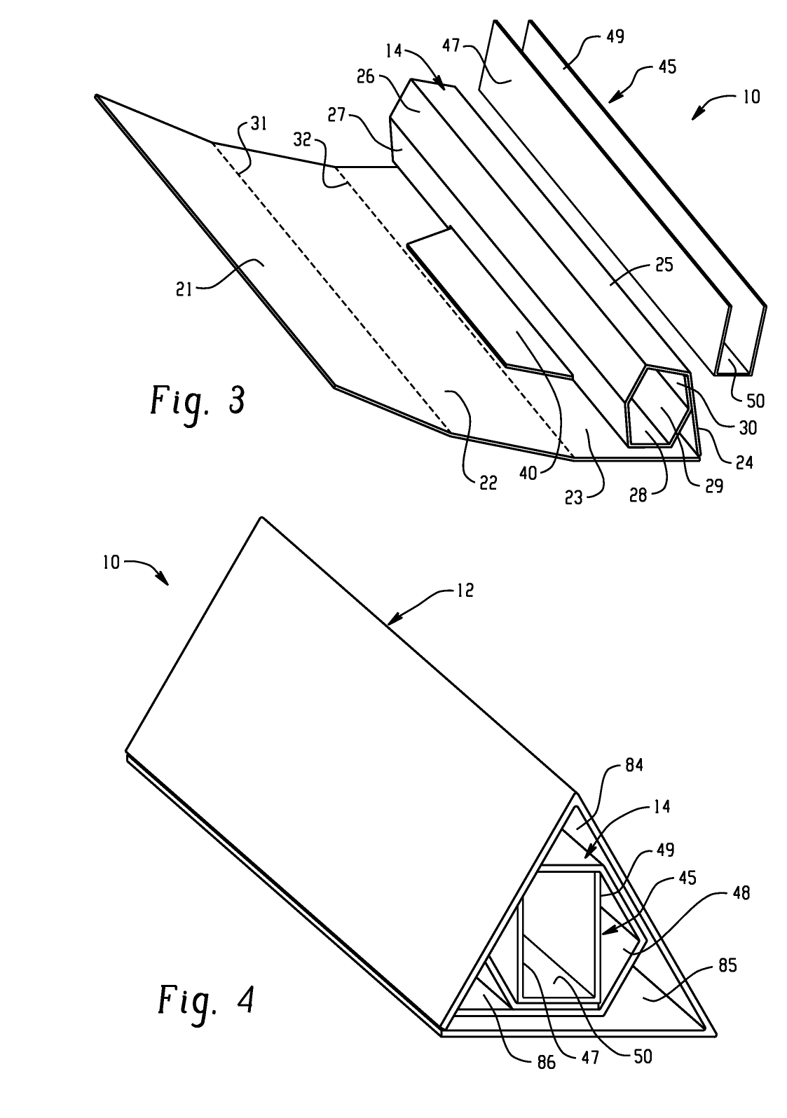

FIG. 3 shows an end perspective view of the hollow inner portion 14 as the elongate structure 10 is being assembled from the partially-assembled condition shown in FIG. 2 and a reinforcement member 45 nearby. The reinforcement member 45 may be made of the same material as the other components. As illustrated, the reinforcement member 45 has a substantially U-shaped cross-section, which is created by folding a sheet of material such that a first leg 47 and a second leg 49 that are joined by a connecting portion 50 is formed. The first leg 47 and the second leg 49 preferably have the same height (i.e., distance from the connecting portion 50).

During final assembly, the edge 44 of the extension tab 40 is substantially aligned with the second fold line 32, with the outer side of the eighth panel 28 pressed into contact with the inner side of the third panel 23. Next, the second panel 22 is folded such that the outer side of the sixth panel 26 is pressed into contact with the inner side of the second panel 22. Then, the reinforcement member 45 is inserted into the hollow inner portion 14. The reinforcement member 45 may be friction fit in the hollow inner portion 14 and/or adhesive may be used. The reinforcement member 45 provides great rigidity to the structure, while only marginally increasing the overall weight of the structure.

Finally, the outer side of the fourth panel 24 is pressed into contact with the inner side of the first panel 21 to form a fully assembled elongate structure 10, as shown in FIG. 4. Glue, adhesive tape and/or mechanical fasteners can be used to secure the outer side of the fourth panel 24 to the inner side of the first panel 21.

Referring to FIG. 4, as mentioned above, the resulting elongate structure 10 includes the hollow inner portion 14 in the shape of the hexagonal tubular structure disposed within the hollow outer portion 12 in the shape of a triangular tubular structure. The hollow inner portion 14 supports the sidewalls of the hollow outer portion 12, which substantially diminishes the probability of collapse or bending along the longitudinal axis of the elongate structure 10. In addition, a hollow channel 48 having multiple faces is defined by the hollow inner portion 14 and can receive and maintain the integrity of rolled sheet goods and other materials during transit, thereby serving as a shipping container. The reinforcement member greatly increasing the resistance to collapse or bending for the elongate structure 10.

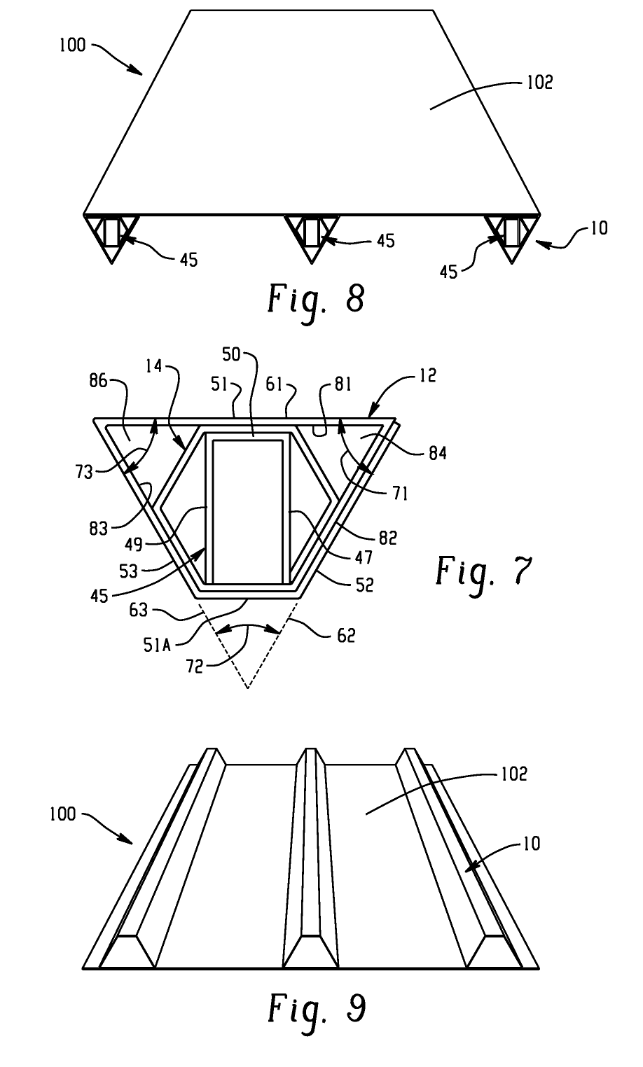

Still referring to FIG. 4 and also to FIG. 7, when the elongate structure 10 is fully assembled, the hollow outer portion 12 is defined by a first outer side surface 51 that defines a first plane 61, a second outer side surface 52 that defines a second plane 62 and a third outer side surface 53 that defines a third plane 63 (shown in FIG. 7). The intersection of the first plane 61 and the second plane 62 form a first dihedral angle 71, the intersection of the second plane 62 and the third plane 63 form a second dihedral angle 72, and the intersection of the third plane 63 and the first plane 61 form a third dihedral angle 73. The sum of the first, second, and third dihedral angles 71, 72, 73 is about 180° (shown in FIG. 7).

Still referring to FIGS. 4 and 7, when the elongate structure 10 is fully assembled the hollow inner portion 14 is in contact with a first inner side 81, a second inner side 82, and a third inner side 83 of the hollow outer portion 12. Further, at least one panel defining the hollow inner portion 14, as explained above, extends between the first and second inner sides 81, 82 to define a hollow triangular channel 84, and between the third and first inner sides 83, 81 to form a hollow triangular channel 86 of the hollow outer portion 12 (see FIGS. 4 and 7). As shown in FIG. 4, a panel defining the inner portion 14 also extends between the second and third inner sides 82, 83 to define a hollow triangular channel 85. No such hollow triangular channel (85 in FIG. 4) is present in the embodiment shown in FIG. 7.

It will be appreciated that rather than forming the elongate structure 10 using a single sheet of material, it would also be possible to form the elongate structure 10 via a combination of two portions that would include the hollow outer portion 12 comprised of a generally triangular tubular structure and a separate and distinct hollow inner portion 14 comprised of a polygonal tubular structure.

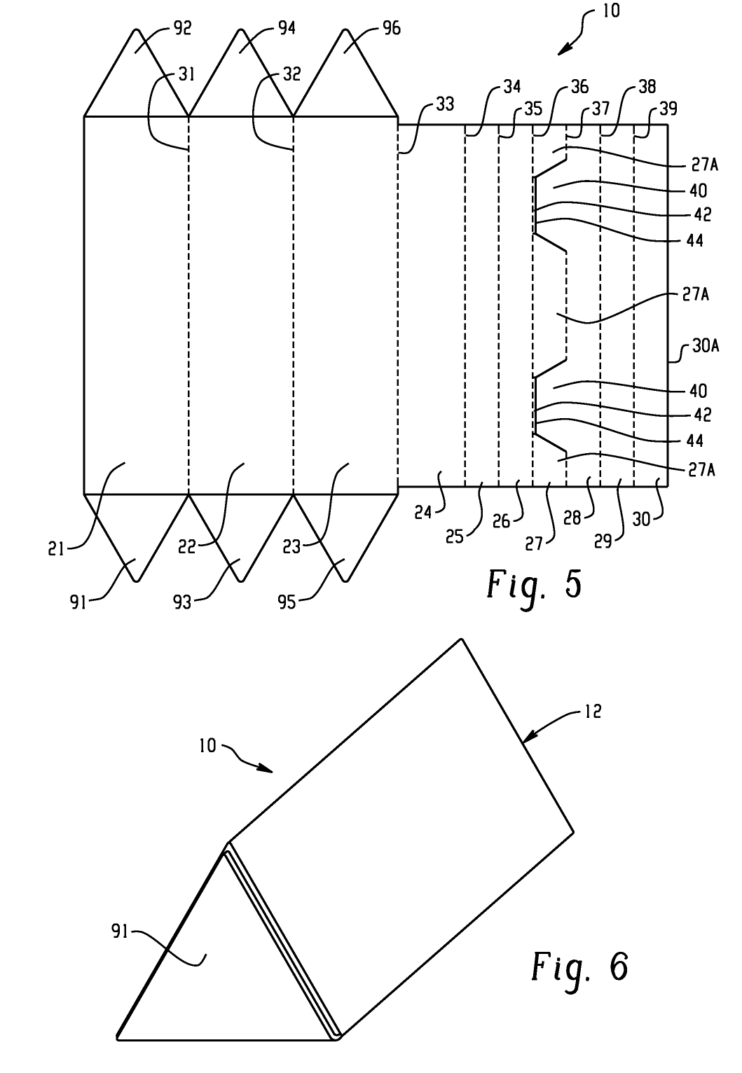

FIGS. 5 and 6 show another exemplary embodiment of an elongate structure 10. FIG. 5 shows the elongate structure 10 in a completely unassembled state and FIG. 6 shows the elongate structure 10 in a fully assembled state. The same reference numbers used in FIGS. 1-4 to identify portions of the elongate structure 10 are also used in FIGS. 5 and 6 to identify similar portions of the elongate structure 10.

The elongate structure 10 shown in FIGS. 5 and 6 differs from the elongate structure 10 shown in FIGS. 1-4 in the following respects: (1) two extension tabs 40 are used in the elongate structure 10, meaning that the seventh panel 27 is divided into three portions 27A; and (2) triangular end flaps 91, 92, 93, 94, 95, 96 extend from the first panel 21, the second panel 22 and the third panel 23, respectively; and (3) the length of the second panel 22 is greater than the length of the third panel 23, and the length of the first panel 21 is greater than the length of the second panel 22.

The additional length of the first panel 21 allows triangular end flaps 91, 92 to fold down and cover triangular end flaps 93, 94 respectively, extending from the second panel 22. Further, the additional length of the second panel 22 allows triangular end flaps 93, 94 to fold down and cover triangular end flaps 95, 96 respectively, extending from the third panel 23. Preferably, the length of the fourth panel 24, the fifth panel 25, the sixth panel 26, the seventh panel 27, the eighth panel 28, the ninth panel 29 and the tenth panel 30 are the same, but are less than the length of the third panel 23. The difference in length between the successive panels is preferably equal to the thickness of the material used to form the elongate structure 10. It will be appreciated that when in an assembled condition, the hollow inner portion 14 serves to prevent the end flaps 95, 96 from being forced completely into the hollow channel 48 defined by the hollow outer portion 12. Because the end flaps 95, 96 are supported, subsequent end flaps 93, 94 and 91, 92 overlap to form a three-ply end cap, which can be easily secured through the use of glue, tape or other means. It will be appreciated that the end flaps could be adapted to be secured by other means, such as tabs and slots and that the number of end flaps could be varied from one to three.

FIG. 6 shows the elongate structure 10 of the third embodiment in a fully assembled state. To close the end flaps, end flap 95 is folded over first, then end flap 93 is folded over onto end flap 95, and finally, end flap 91 is folded over onto end flap 93. Similarly, on the opposite side of the elongate structure 10, end flap 96 is folded over first, then end flap 94 is folded over onto end flap 96, and finally, end flap 92 is folded over onto end flap 94. The end flaps are then secured using adhesive, tape or fasteners.

Referring again to FIG. 7, which shows another exemplary embodiment of the elongate structure 10. This embodiment is similar to the embodiment described above with the exception that the present embodiment has a hollow outer portion 12 that defines the shape of a trapezoid and more specifically, an isosceles trapezoid. An isosceles trapezoid is a trapezoid where the two non-parallel sides and base angles are equal. The hollow outer portion 12 includes a large parallel outer side 51, described in the first embodiment above, and a small parallel side 51A. The hollow inner portion 14 is similar to the hollow inner portion described in the first embodiment. As noted in paragraph [0034], the hollow outer portion 12 is defined by a first outer side surface 51 that defines a first plane 61, a second outer side surface 52 that defines a second plane 62 and a third outer side surface 53 that defines a third plane 63. The intersection of the first plane 61 and the second plane 62 form a first dihedral angle 71, the intersection of the second plane 62 and the third plane 63 form a second dihedral angle 72, and the intersection of the third plane 63 and the first plane 61 form a third dihedral angle 73. The sum of the first, second, and third dihedral angles 71, 72, 73 is about 180°. The second plane 62 and the third plane 63 intersect along a line that is parallel to, but spaced away from the small parallel side 51A. Thus, while the hollow outer portion 12 defines a trapezoid in cross-section, there are three sides that define planes that intersect to define a generally triangular shape in cross section.

Further, the elongate structure 10 shown in FIG. 7 possesses similar characteristics and features as the elongate structure 10 previously described and shown in FIGS. 1-4. For example, the elongate structure 10 in FIG. 7 includes the reinforcement member 45. In addition, because the small parallel side 51A is parallel to the large parallel outer side 51, the elongate structure according to the fifth embodiment of the invention can be used in applications other than shipping containers. For example, FIGS. 8-10 show another application for the elongate structure 10 disclosed herein. Specifically, FIGS. 8-11 illustrate several embodiments of a pallet incorporating the elongate structure 10, which serve as pallet runners for the pallet.

FIG. 8 shows an embodiment of a pallet 100 incorporating the elongate structure 10 according to an embodiment of the invention. The pallet 100 is formed by securing at least two, and preferably three or more, elongate structures 10 to a sheet or deck 102 of material such as corrugated cardboard. The plurality of elongate structures 10 can be parallel to one another and are affixed to a same side of the deck 102. Thus, the elongate structures 10 serve as pallet runners for the pallet 100. The elongate structures 10 can be secured to the sheet 102 using adhesives and/or mechanical fasteners such as staples. The elongate structures 10 support the sheet 102 to which they are fastened above the surface that supports the elongate structures 10. The space between the bottom surface of the sheet 102 and the surface on which the elongate structures 10 rest is sufficient to permit the passage of forks of a forklift or other conventional pallet moving device. The sheet 102 is adapted to support one or more goods in the same manner as conventional wooden pallets.

It will be appreciated that the number and spacing of elongate structures 10, as well as the area of the sheet 102 to which they are secured, can be modified and adjusted for specific applications. A greater number of elongate structures 10 can be used for constructing pallets that are intended to support heavier loads. Furthermore, the number and thickness of the materials used to form the elongate structures 10 and sheets 102 can be varied and customized for the particular application. A two-way pallet is shown in the illustrated embodiment. A two-way pallet includes gaps on the front and rear for the forks of a lift truck, tow motor or pallet jack. It will be appreciated that several shorter elongate structures 10 can be aligned in a spaced apart manner to form a four-way pallet. A four-way pallet also includes gaps on both sides of the pallet for the forks of a lift truck, tow motor or pallet jack.

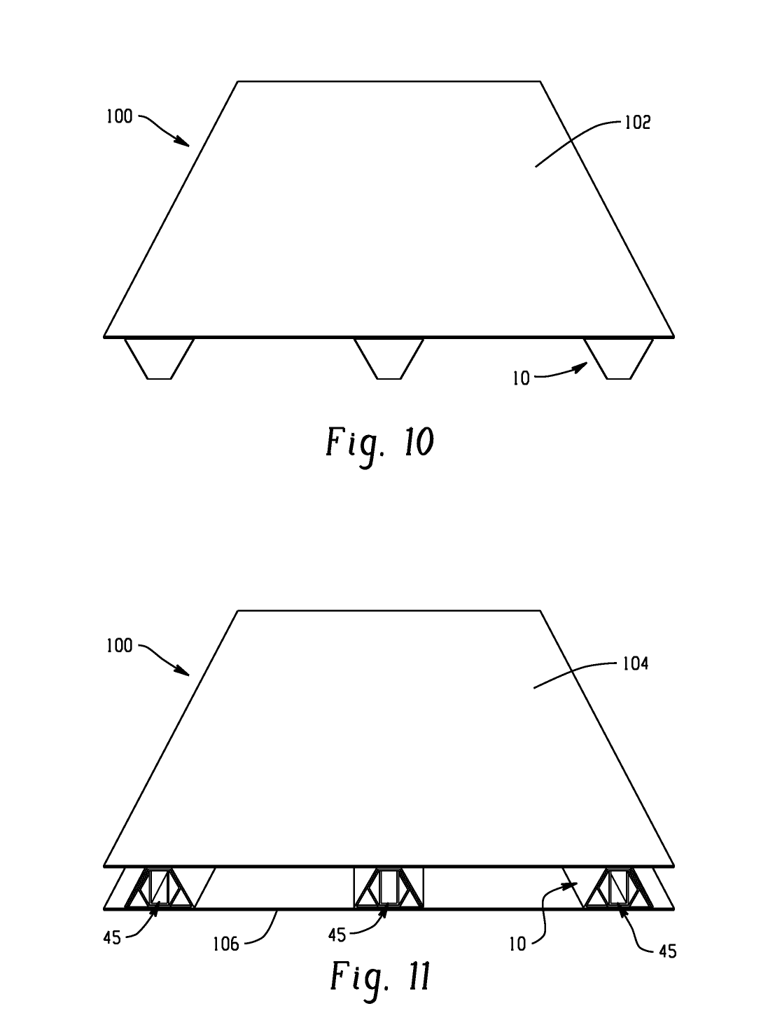

FIGS. 9 and 10 show another embodiment of the pallet 100. FIG. 9 shows the pallet 100 in an inverted position that includes three elongate structures 10 according. FIG. 10 shows the pallet 100 in an upright position. Although not apparent from the drawings, it is considered apparent that the pallet 100 could include the reinforcement member 45 as discussed hereinbefore. As mentioned above, the hollow outer portion 12 of the elongate structures 10 defines a trapezoidal cross-section. In this embodiment, integrated end flaps 91-96 described above are used to close each end of the elongate structures 10. As shown in FIGS. 9 and 10, the large parallel side 51 of the two parallel sides of the elongate structure 10 is secured to a bottom surface of the sheet material 102. Thus, the small parallel side 51A is in contact with the surface that the elongate structure 10 rests, thereby leaving a space between the resting surface and the bottom surface of the sheet 100 to facilitate pallet moving equipment to pass.

FIG. 11 shows yet another embodiment of the pallet 100. This embodiment is similar the embodiment shown in FIGS. 9 and 10 with the exception that this embodiment includes two sheets of material. Specifically, multiple elongate structures 10 are positioned between a top sheet 104 and a bottom sheet 106 of material to thereby form the pallet 100. Again the hollow outer portion 12 of the elongate structures 10 defines a trapezoidal cross-section. In addition, in this embodiment, each end of the elongate structures 10 is open and the hollow inner portion 14 contains the reinforcement member 45. Thus, It will be appreciated that each end of the elongate structures 10 where the hollow outer portion 12 defines a trapezoid can be open, closed using external end caps (not shown), or closed using the integrated end flaps 91-96 made of the same material as the elongate structures 10.

It will be appreciated that the orientation of the elongate structures 10 can be altered. Specifically, in the embodiment shown in FIG. 11, the small parallel side 51A of each elongate structure 10 is attached to the top sheet 104 and the large parallel side 51 of each elongate structure 10 is attached to the bottom sheet 106. In other embodiments, the small parallel side 51A of one or more elongate structures 10 can be attached to the bottom sheet 106 and the large side 51 of one or more elongate structures 10 can be attached to the top sheet 104.

It will be appreciated that the elongate structure disclosed herein may take on several properties and alternative configurations. For example, the elongate structure can be formed from sheet materials such as corrugated paper, solid core fiberboard material, plastic corrugated sheeting and other materials. The panels of the elongate structure can be single walled, double walled or greater, if desired. The materials from which the elongate structure is constructed can be waterproof, water-resistant and/or can be treated to provide water resistance, if desired. The sheet material (also known as the deck) for the pallets disclosed herein can be made of the same material as the elongate structure or can be made of a different material. Furthermore, composites of two or more different materials can be used.

It will be appreciated that the elongate structure and the pallets according to the invention provide many advantages and benefits over the prior art. For example, pre-cut and pre-creased sheets for use in constructing the elongate structure according to the invention can be shipped to end users and stored by end users in a compact, stacked arrangement until the time of use. At that time, the end user can construct as many elongate structures as are presently needed.

Elongate structures according to the invention are lightweight, yet very strong. Further, the triangular or trapezoidal cross-sectional hollow outer portion lends well to the creation of custom pallet designs without the need to maintain a large inventory of different elongate structures. Jigs can be created by end users to suit the end user's particular needs for specific shipping needs. In addition, pallets having different configurations can be made on-site by end users using the same materials quickly and at relatively low cost. Furthermore, the pallets cut down on used pallet storage and warehouse hygiene issues.

Pallets according to the invention can be made from 100% recycled materials. Furthermore, the pallets themselves can also be recycled. Preferably, the pallets according to the invention do not include nails or other metallic fasteners, which can cause injury hazards to employees.

Pallets according to the invention are particularly suitable for use in shipping low density products, such as potato chips and other snacks. But due to their substantial strength to weight ratio, they can be used to support many goods that heretofore have been shipped on traditional wooden pallets.

Because the elongate structure disclosed herein is exceptionally strong the elongate structure can have many applications. For example, as mentioned above, the elongate structure can be used as a shipping container to ship rolled sheet matter. Further, the elongate structure can be used as a pallet runner or as a corner post for large shipping containers.

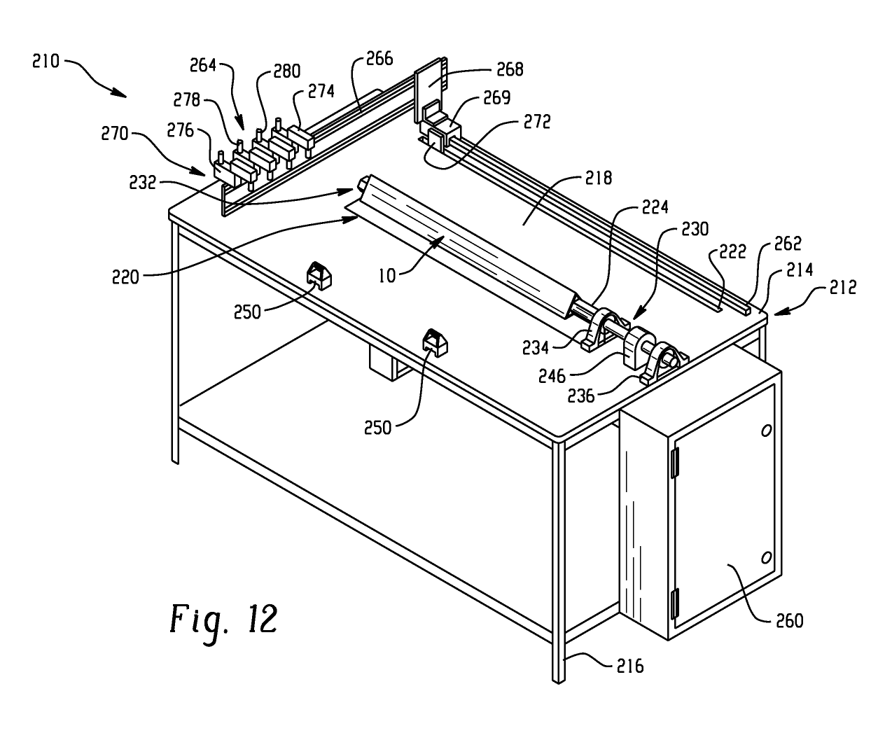

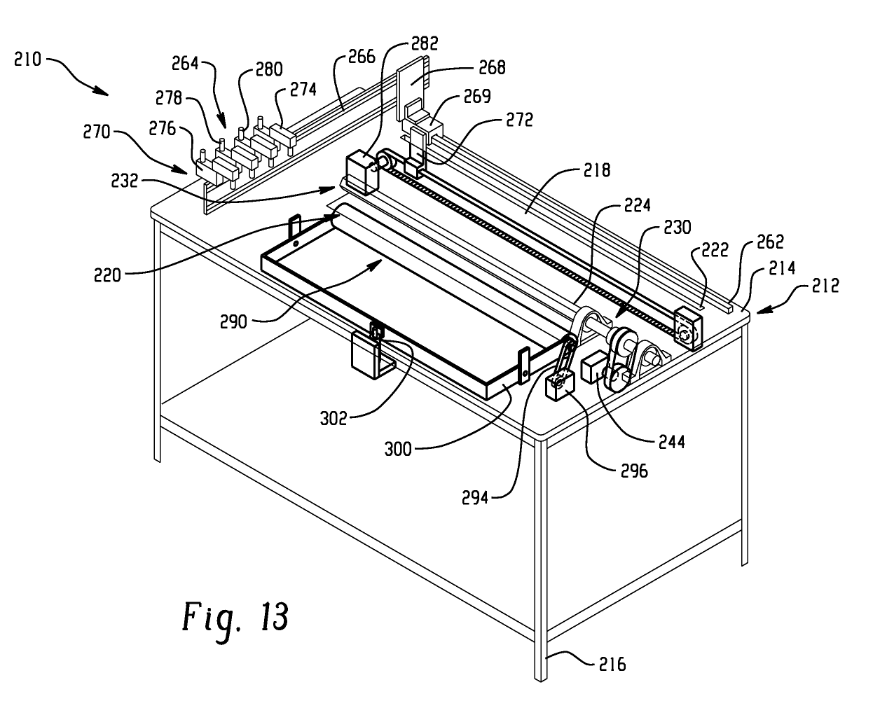

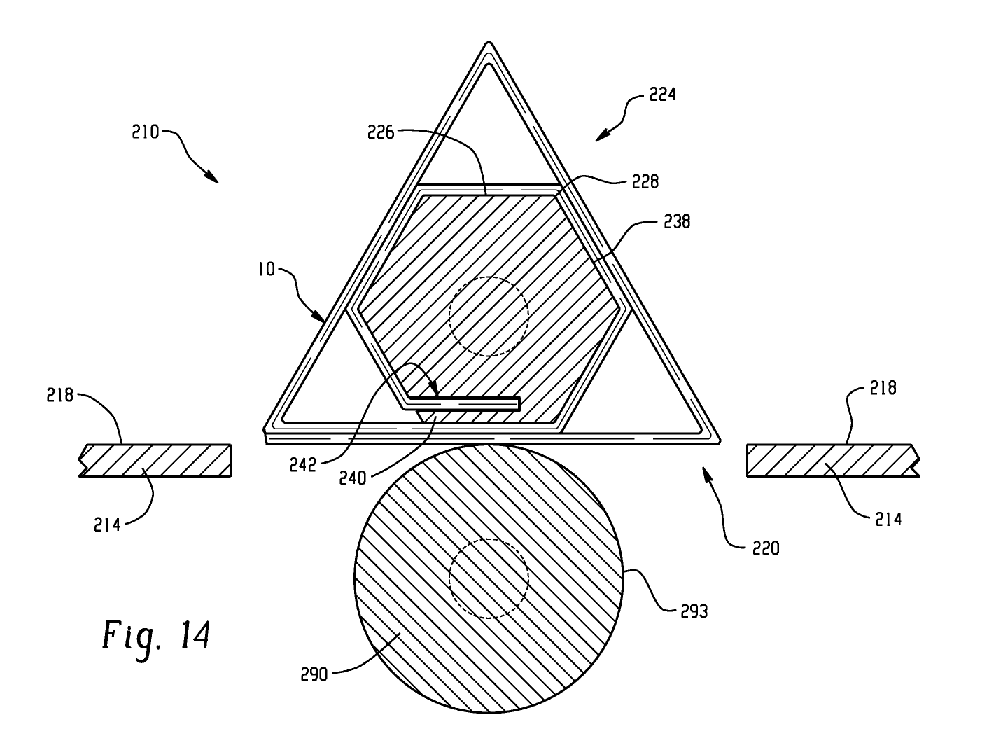

Referring now to FIGS. 12-13, a device 210 is shown. The device 210 includes a table 212, a mandrel 224, a controller 260, an adhesive dispenser 264, and a tensioning member 290.

The table 212 with a tabletop 214 may include legs 216 as shown, but it is not required. The tabletop 214 includes a working surface 218 that extends in a generally horizontal manner and can be planar to aid in operation of the device 210 as will be discussed hereinbelow. The tabletop 214 defines a tensioning member passageway 220 and an adhesive dispenser slot 222. Both the tensioning member passageway 220 and the adhesive dispenser slot 222 are illustrated as being rectangular in shape, but other shapes are possible and contemplated. The tensioning member passageway 220 and the adhesive dispenser slot 222 allow for various components to pass through the tabletop 214 as will be discussed in more detail hereinafter. The table 212 may be constructed of any number of materials that provide adequate strength to support the various components.

With reference to FIGS. 12-14, and particularly FIG. 14, the mandrel 224 is shown. FIG. 14 is a partial sectional view of FIG. 12 so as to show the table 212, the mandrel 224, and tensioning member 290. The mandrel 224 can have primarily a hexagonal cross-section including sides 226 and obtuse vertices 228. Accordingly, when the mandrel 224 is hexagonal, there are six sides and six vertices. However, it will be appreciated that the mandrel 224 could be any number of different cross-sectional shapes. For example, the mandrel 224 could be circular in cross-section. Alternatively, the mandrel 224 could be generally hexagonal, but with a number of recesses cut into the sides. This would result in a shape that is somewhat star-shaped. These recesses reduce the contact area between the mandrel 224 and the elongate structure 10, thereby easing removal of the elongate structure 10 once the elongate structure 10 have been completely formed.

As shown in FIG. 12, the mandrel 224 is cantilevered on the working surface 218 and has a first end 230 and a second end 232. The first end 230 is rotatably attached to the table 212 via first and second pillow blocks 234, 236 and have a circular cross-sectional shape. The second end 232 of the mandrel 224 is free and unattached and exhibits the hexagonal cross-sectional shape. Because the second end 232 is free, the elongate structure 10 can be removed from the device 210 once winding and folding has been completed.

With reference once again to FIG. 14, the mandrel 224 includes a side wall 238 that is made up of the hexagonal sides 226 and the obtuse vertices 228. Because the mandrel 224 has a hexagonal cross-section, the vertices 228 are radially aligned with the fold lines of the sheet material of the elongate structure 10. As shown in FIG. 14, the mandrel 224 may have a solid construction. Alternatively, as will be discussed in more detail later, the mandrel 224 may define a chamber or manifold that extends longitudinally from the first end 230 to the second end 232. The mandrel 224 may be made of any number of materials including metal and/or polymeric materials that provide sufficient strength and rigidity for the elongate structure 10 to be wrapped around the mandrel 224 without significant deformation or bending.

The device 210 can also include a gripper blade 240. The gripper blade 240 may be a component separate from the mandrel 224 or may be integral to the mandrel 224. The gripper blade 240 can have a rectangular cross-sectional shape and can longitudinally extend along the mandrel 224 between the first end 230 and the second end 232. The gripper blade 240 may be made of the same material as the mandrel 224 or of another material that is sufficient to resist significant warping and deformation during use.

The gripper blade 240 cooperates with the side wall 238 to define a sheet material slot 242. The sheet material slot 242 defines a distance that is greater than the thickness of the sheet material. The gripper blade 240 releasably secures the sheet material of the elongate structure 10 to the mandrel 224. When a leading edge of the sheet material of the elongate structure 10 is located within the sheet material slot 242, the sheet material is free to move between the side wall 238 of the mandrel 224 and the gripper blade 240. Further, the gripper blade 240 and the side wall 238 of the mandrel 224 are generally parallel to one another. The sheet material slot 242 defines a distance that is greater than a thickness of the sheet material of the elongate structure 10.

FIG. 13 is the same view as FIG. 12, but with the table top 214 being transparent to allow a better view of the underside of the table top 214. For ease of viewing, the controller 260 is also not shown. With reference to FIG. 13, a motor 244 is rotationally linked to the mandrel 224. This may be accomplished by any number of means including a chain or belt that would be disposed within a mandrel housing 246. Alternatively, the motor 244 may be directly linked to the mandrel 224 via a gear train. The mandrel housing 246 at least partially surrounds the mandrel 224 and prevents access to various pinch points that will be located within the housing 246 to improve operator safety. The motor 244 may be any number of commercially available motors as is known in the art. The motor 244 is operably linked to the controller 260 as will be discussed in more detail hereinafter. The motor 244 ensures that the sheet material is wrapped about the mandrel 224 such that the sheet material folds at the fold lines and forms the elongate structure 10.

With reference to FIG. 12, a pair of deadman's switches 250 are shown. These switches 250 are known in the art and require that an operator continuously actuate both switches for the device 210 to operate. The switches 250 ensure that both of the operator's hands are away from any moving components of the device 210. The switches 250 are connected to the controller 260.

With reference once again to FIG. 12, the rail 262 is shown. The rail 262 can extend in a direction generally parallel to the mandrel 224 and the adhesive dispenser slot 222. The rail 262 has a stepped type cross-sectional shape. The rail 262 cooperates with a slide 269 of the adhesive dispenser 264 to allow slidable movement of the adhesive dispenser 264 along the table 212 as will be discussed in more detail hereinafter. The rail 262 may be a separate component from the table 212. Alternatively, the rail 262 may be integral to the table 212. The rail 262 can be constructed of any number of materials that prevent binding between the rail 262 and the adhesive dispenser.

The adhesive dispenser 264 includes a beam 266 with a rail end 268 and a nozzle end 270. Near the rail end 268 includes a slide 269 for slidable engagement with the rail 262. The rail 262 and the slide 269 cooperate to restrict movement of the adhesive dispenser 264 to a direction generally parallel to the mandrel 224. The beam 266 can extend in a generally horizontal manner transverse to the adhesive dispenser slot 222.

At the nozzle end 270 of the adhesive dispenser 264, a plurality of nozzles are included. These nozzles include a first nozzle 274, a second nozzle 276, a third nozzle 278, and a fourth nozzle 280. The first nozzle 274 is disposed on the beam 266 between the second nozzle 276 and the rail end 268. The third nozzle 278 and the fourth nozzle 280 are located on the beam 266 between the first nozzle 274 and the second nozzle 276. The nozzles 274, 276, 278, 280 may be connected to tanks that supply adhesive.

The first nozzle 274 dispenses a first adhesive and the second nozzle disposes a second adhesive. The second adhesive has a set time that is less than the set time of the first adhesive. As the second adhesive from the second nozzle 276 is applied near a trailing end of the sheet material of the elongate structure 10, the trailing edge is able to adhere much more rapidly and prevent unwinding of the elongate structure 10 while the first adhesive from the first nozzle 274 continues to dry. It is noted that the third nozzle 278 and the fourth nozzle 280 dispense the first adhesive. Further, the first adhesive can have a greater holding strength than the second adhesive. The first and the second adhesives may be holt-melt or cold-melt type adhesives.

Because of the layout of the nozzles 274, 276, 278, 280, the adhesives are dispensed onto the elongate structure 10 such that once the elongate structure 10 is completely formed, the first adhesive is between the hollow inner portion 14 and the first inner side 81, the second inner side 82, and the third inner side 83 of the hollow outer portion 12. Further, the second adhesive is between the second outer side surface 52 and the second inner side 82. It is also noted that the adhesive dispenser 264 allows for either one adhesive or a plurality of adhesives to be applied at once. For example, the first adhesive could be dispensed from the first nozzle 274, the third nozzle 278, and the fourth nozzle 280, while the second adhesive is being simultaneously dispensed from the second nozzle 276.

The adhesive dispenser 264 can also include a movement arm 272 that extends vertically from the beam 266 through the adhesive dispenser slot 222 of the table 212. As shown in FIG. 13, the movement arm 272 is operably linked to a motor 282. While the adhesive dispenser 264 is shown linked to the motor 282 via a chain and sprocket arrangement, it will be appreciated that other methods of joining these components together are possible and contemplated. For example, the movement arm 272 could be linked via a gear train or belt arrangement. Rotation of the motor 282 causes movement of the movement arm 272 with respect to the table 212.

Because movement of the adhesive dispenser 264 is limited by the engagement between the slide 269 and the rail 262, rotation of the motor 282 causes the dispenser 264 to move in a path that is generally parallel to the mandrel 224. The motor 282 is a commercially available component, as is known in the art. The motor 282 and the adhesive dispenser 264 are operably associated with the controller 260 as will be described hereinafter. Because of this association, movement of the adhesive dispenser 264 along the rail 262 and precision dispensing of the adhesives can occur.

With reference to FIGS. 12-14, and more particularly to FIG. 14, the tensioning member 290 is shown. Initially, it is noted that while it is preferred that the device 210 includes the tensioning member 290, the device 210 can function without the tensioning member 290 and the tensioning member 290 is not required. The tensioning member 290 can have a circular cross-section and includes a contact face 293. The tensioning member 290 is rotatably attached to the table 212 and can utilize a pin-type connection cooperating with a linkage 300 to connect the tensioning member 290 to the table 212.

The linkage 300 allows the tensioning member 290 to move toward and away from the mandrel 224. Further, the linkage 300 allows the tensioning member 290 to extend through the tensioning member passageway 220 of the table 212. Movement of the linkage 300 is provided by a hydraulic cylinder 302 as is known in the art. Control of the hydraulic cylinder 302 is governed by the controller 260 as will be discussed below.

As shown in FIG. 13, the tensioning member 290 is linked to a motor 296 via a belt 294. However, it will be understood that the tensioning member 290 could be linked to the motor 296 by any number of commercially available means, including for example a gear train or chain and sprocket arrangement. The motor 296 is operably connected to the controller 260. Further, the motor 296 is known in the art.

The tensioning member 290 rotates in a direction opposite the rotation of the mandrel 224. Further, it is noted that the tensioning member 290 may rotate at a speed slightly less than the rotational speed of the mandrel 224 and the distance between the tensioning member 290 and the mandrel 224 can be varied. This ensures that the sheet material of the elongate structure 10 has a proper amount of tension so that folding along the creases of the sheet material occurs while the sheet material is wrapped around the mandrel 224. Specifically, as the distance between the mandrel 224 and the tensioning member 290 is decreased and as the rotational speed difference between the mandrel 224 and the tensioning member 290 is increased, the rotational tension in the sheet material of the elongate structure 10 is increased.

The linkage 300 in cooperation with a hydraulic cylinder 302 allows for movement of the tensioning member 290 toward and away from the mandrel 224. Specifically, the tensioning member 290 can extend through the tension member passageway 220 so that varying amounts of tension can be applied to the sheet material of the elongate structure 10.

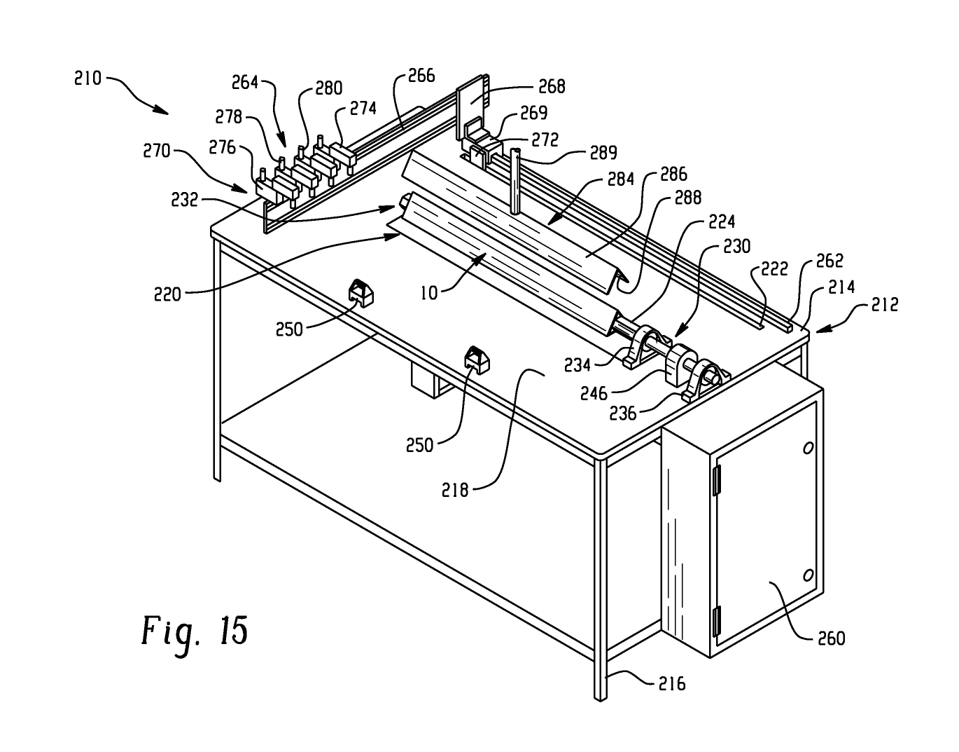

With reference to FIG. 15, the device 210 is shown with a compressive member 284 and all other components remaining the same as compared to FIGS. 12-13. The compressive member 284 includes a first arm 286 and a second arm 288 that are connected to a motion rod 289. The first arm 286 faces toward the second arm 288 and these arms 286, 288 cooperate with one another to define a V-shaped structure.

The compressive member 284 receives a portion of at least one of the creases of the sheet material of the elongate structure 10 when the motion rod 289 is moved toward the mandrel 224. More specifically, with reference to FIGS. 7 and 15, the compressive member 284 releasably presses outer side surfaces 52 and 53 of the hollow outer portion 12 of the elongate structure 10 against the inner portion 14 of the elongate structure 10 after the sheet material has been wrapped about the mandrel 224. Further, although the reinforcement member 45 is shown in FIG. 7, it is understood that the reinforcement member 45 is not inserted into the elongate structure 10 until after the elongate structure 10 is removed from the device 210.

The motion rod 289 is attached to any number of motion providing devices as is known in the art. All that is required of the motion providing device is the ability to selectively move the motion rod 289 toward and away from the mandrel 224 based upon communication with the controller 260. In operation, the compressive member 284 moves in a vertical direction (i.e., toward and away from the table 212) so as to compress the sheet material of the elongate structure 10 between the mandrel 224 and the first arm 286 and the second arm 288. This motion ensures that the elongate structure 10 is formed into the proper shape.

As shown in FIGS. 12 and 15, the controller 260 is located on a side of the table 212. However, other locations are possible and contemplated. The controller 260 is linked to motor 244, deadman's switches 250, adhesive dispenser 264, motor 282, the motion providing device, motor 296, and hydraulic cylinder 302. Further, it is contemplated that the controller 260 could be connected to any number of sensors. These sensors could be used to determine the exact orientation of the sheet material of the elongate structure 10 or of the positions of the various components of the device 210. The controller 260 may be a commercially available device that provides for the control and operation of a variety of electronic components. It is understood, that the controller 260 may be connected to the various components by wired or other techniques, such as wireless communication methods.

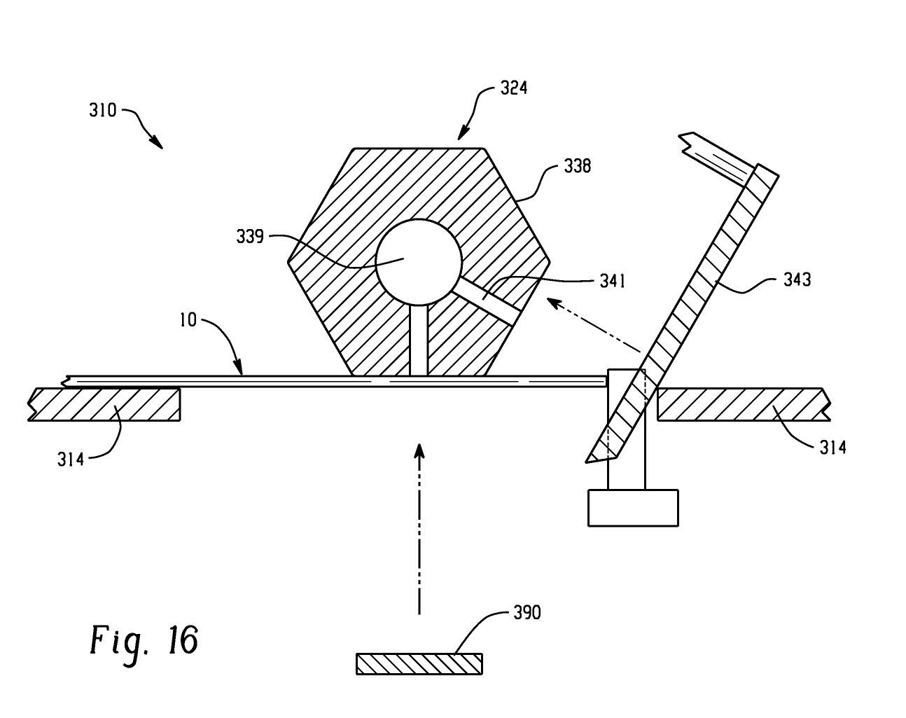

With reference to FIGS. 16-19, a cross-sectional view of an alternative device is shown. Specifically, a device 310 is illustrated. The device 310 includes a table 314, a mandrel 324, a forming plate 343, and a tension plate 390. The device 210 and the device 310 share all of the same components and characteristics unless noted herein.

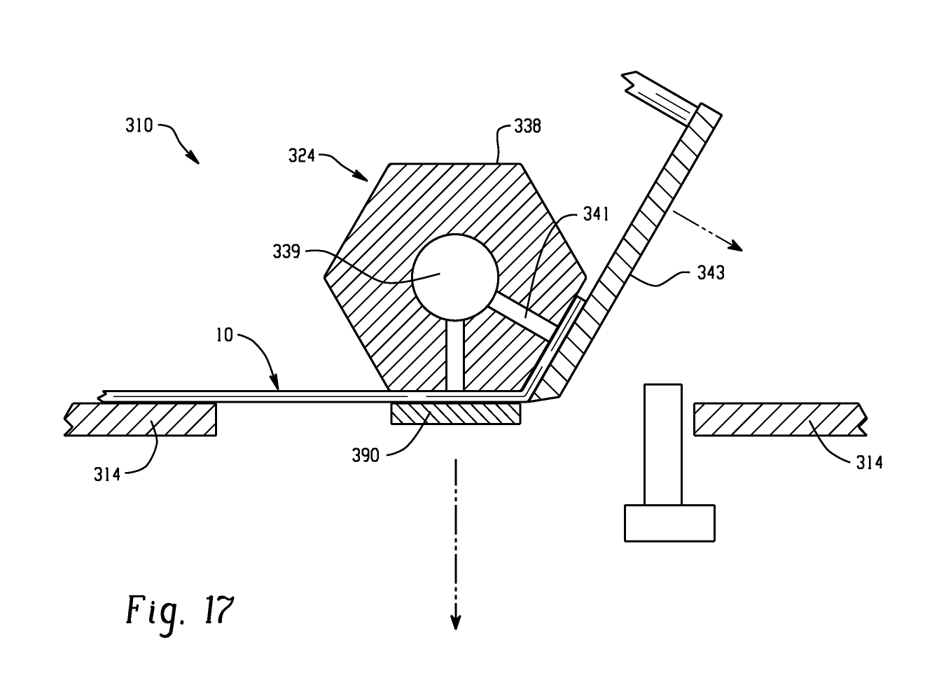

The mandrel 324 of the device 310 includes a side wall 338 that defines a manifold 339. The manifold 339 extends longitudinally along the mandrel 324 between the first end 230 and second end 232, as shown in FIG. 12. The side wall 338 of the mandrel 324 further defines a series of ports 341 that extend radially from the manifold 339. The ports 341 may be disposed on the two sides of the mandrel 324 that initially contact the elongate structure 10 as illustrated in FIG. 17. Alternatively, there may only be ports on one side of the mandrel that first contacts the elongate structure 10 (see, e.g., as in FIG. 16). In that instance, the port 343 would be located on the side 326 of the mandrel 324 that faces the forming plate 343 in FIG. 16. This would ensure that the leading edge of the elongate structure 10 is firmly attached to the mandrel 324. The manifold 339 is then fluidly connected to a vacuum pump (not shown) that is controlled by the controller 260. This allows for a vacuum pressure to be selectively drawn on the sheet material as will be described in more detail hereinafter.

Although not illustrated, it is understood that the mandrel 324 may include ports that would selectively discharge pressurized air toward the elongate structure 10. Specifically, pressurized air would be discharged from these ports when the elongate structure 10 was to be removed from the mandrel 324. As can be appreciated, these ports would aid in removing the elongate structure 10 from the mandrel 324.

With particular reference to FIG. 16, the device 310 is shown in an initial position. In this state, the forming plate 343 and the tension plate 390 are in a retracted position. This retracted position means that the forming plate 343 is at a maximum horizontal distance from the mandrel 324 and the tension plate 390 is at a maximum vertical distance from the mandrel 324. While in this state, the sheet material of the elongate structure 10 is inserted into the device 310 until the leading edge of the sheet material contacts the forming plate 343.

Then, as shown in FIG. 17, the tension plate 390 is extended toward the mandrel 324 to fix horizontal movement of the sheet material of the elongate structure 10. Further, the forming plate 343 is extended toward the mandrel so as to force the sheet material into contact with the mandrel 324. While the forming plate 343 and the tension plate 390 are in this position, the vacuum pump is activated. Thus vacuum pressure holds the sheet material on the mandrel 324.

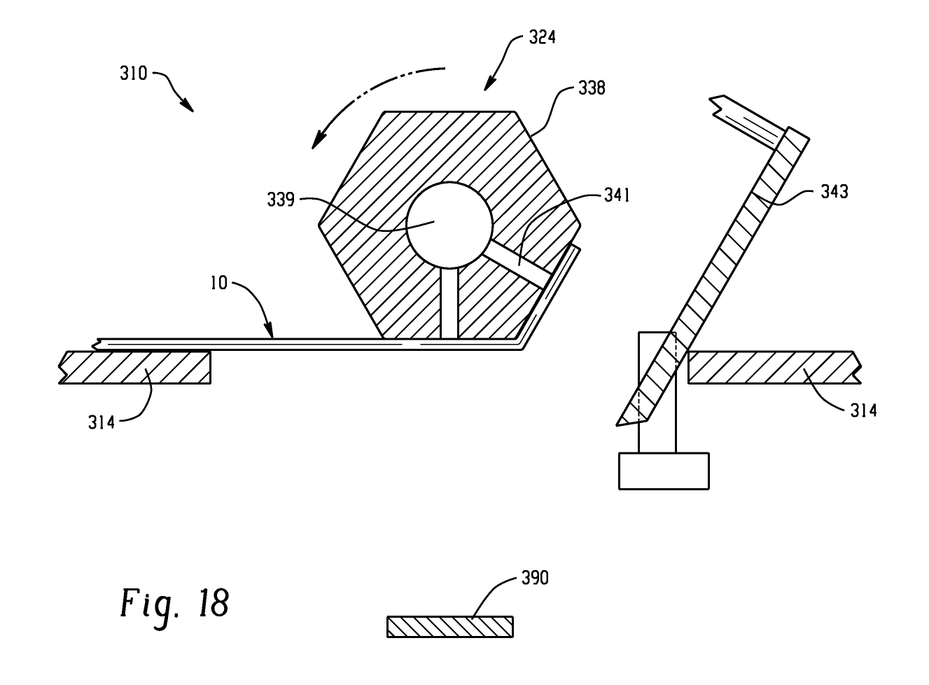

As shown in FIG. 18, the forming plate 343 and the tension plate 390 are retracted. This allows the mandrel 324 to rotate without contact between the mandrel 324 and the plates 343, 390. While the mandrel 324 is rotated, vacuum pressure is maintained to further ensure that the sheet material of the elongate structure 10 remains affixed to the mandrel 324.

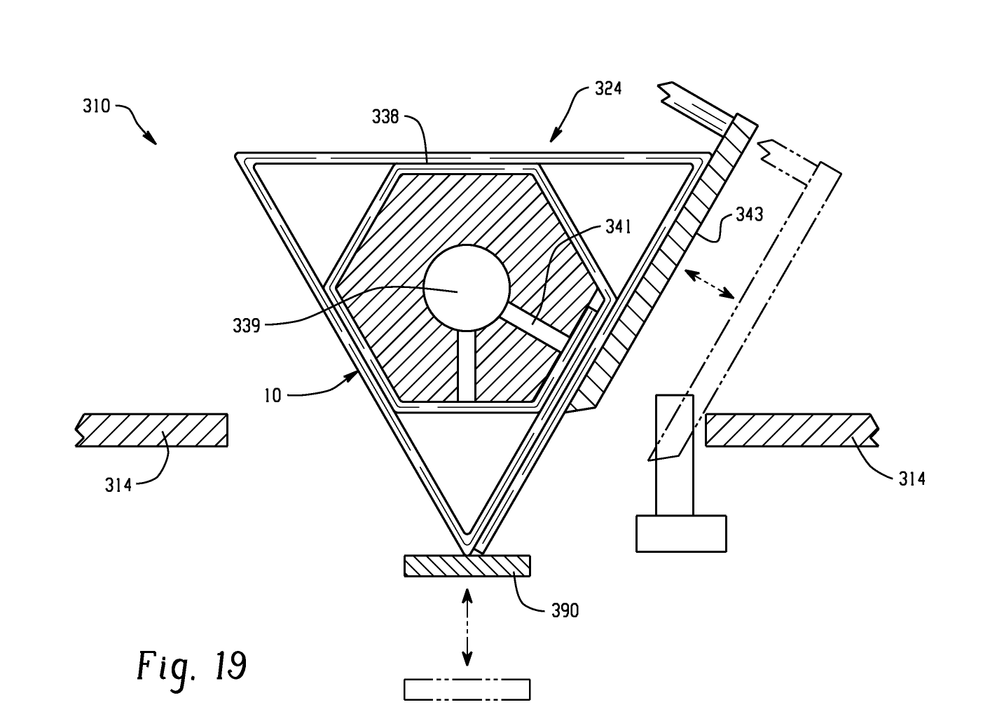

As illustrated in FIG. 19, the elongate structure 10 has been completely wound about the mandrel 324 a total of approximately 660°. At this time, the forming plate 343 extends so as to contact the elongate structure 10 and compress the elongate structure 10 between the forming plate 343 and the mandrel 324. This ensures proper adhesion of the glue that was present on the elongate structure 10 as previously discussed.

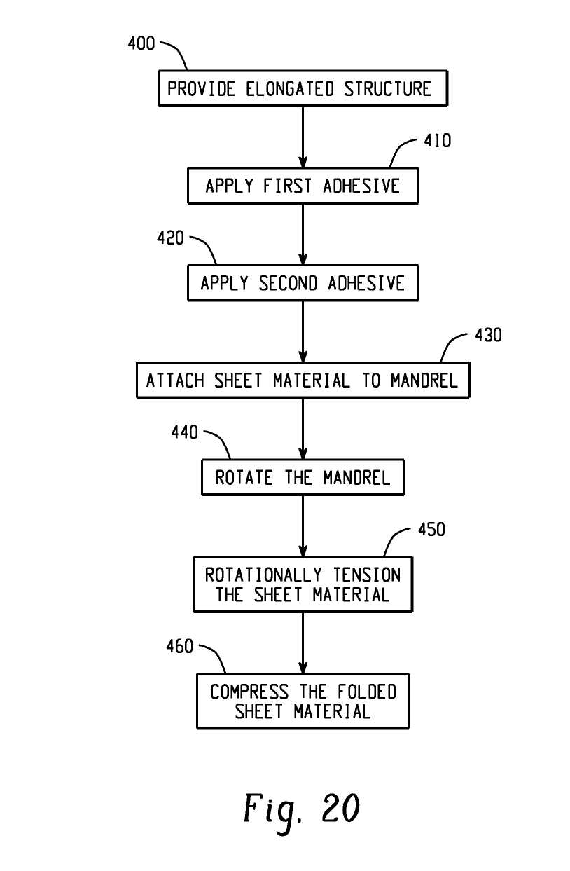

As shown in FIG. 20, a method of manufacturing tubes of sheet material is illustrated. In 400, the elongate structure is provided. In 410, a first adhesive is applied to the sheet material, and in 420 a second adhesive is applied to the sheet material. As mentioned hereinbefore, the second adhesive has a set time that is less than a set time of the first adhesive. It is noted that the first adhesive and the second adhesive may be applied at the same time. In 430, a leading edge of the sheet material is attached to the mandrel. This can be accomplished by inserting the leading edge of the sheet material between a sidewall of the mandrel and a gripper blade of the mandrel, where the sidewall and the gripper blade are generally parallel to one another. Alternatively, the leading edge of the sheet material can be retained to the mandrel by vacuum pressure. In 440, the mandrel is rotated in a first direction to fold the sheet material. In 450, the sheet material is rotationally tensioned with a tensioning member. This is accomplished by rotating the mandrel at a first rotational speed in the first direction, while rotating the tensioning member in a second direction at a second rotational speed. The first direction is opposite the second direction and the first rotational speed is greater than the second rotational speed. In 460, the folded sheet material is compressed between a compressive member and the mandrel. It is noted that the above steps are coordinated through the controller.

As used herein, terms such as “above . . . below . . . up . . . down . . . horizontally” are not intended to limit the appended claims, but are used for ease of description of the relationship of various parts of the illustrated embodiment, it being apparent that various orientations of a device are possible depending upon the environments employed.

It will be appreciated that the above-disclosed and other features and functions, or alternatives or varieties thereof, may be desirably combined into many other different systems or applications. For example, an automatic feeder could be added to supply the sheet material to the device 210. This would allow the device 210 to operate without an operator manually feeding the sheet material into the device 210. Further, an automatic unloader could be associated with the device 210. The automatic unloader would coaxially remove the elongate structure 10 from the mandrel 226 and then place the elongate structure 10 into shipping containers or other desired storage devices. Further still, an automated attachment device could be used to attach the elongate structures 10 to the deck 102. The automatic unloader could also slightly rotate the elongate structure 10 prior to removal from the mandrel 226 as mentioned hereinbefore. Also presently unforeseen or unanticipated alternatives, modifications, variations or improvements therein may be subsequently made by those skilled in the art which are also intended to be encompassed by the following claims.

1. A device for wrapping a substantially flat piece of sheet material provided with a plurality of creases that define fold lines that when folded forms an elongate structure that includes a hollow outer portion and a hollow inner portion disposed within the hollow outer portion, wherein the hollow outer portion includes at least a first outer side surface that defines a first plane, a second outer side surface that defines a second plane, and a third outer side surface that defines a third plane, wherein the first plane intersects with the second plane at a first dihedral angle, the second plane intersects with the third plane at a second dihedral angle, and third plane intersects with the first plane at a third dihedral angle, wherein the sum of the first dihedral angle, the second dihedral angle and the third dihedral angle is about 180°, wherein the hollow inner portion contacts a first inner side of the hollow outer portion opposite the first outer side surface, a second inner side of the hollow outer portion opposite the second outer side surface, and a third inner side of the hollow outer portion opposite the third outer side surface, and wherein the hollow inner portion includes at least a first panel that extends between the first inner side of the hollow outer portion and the second inner side of the hollow outer portion so as to define a first hollow inner triangular channel, and a second panel that extends between the second inner side of the hollow outer portion and the third inner side of the hollow outer portion so as to define a second hollow inner triangular channel, the device comprising:
a mandrel;
a gripper blade for releasably securing the sheet material to the mandrel;
a motor for rotating the mandrel when the sheet material is secured to the mandrel and thereby wrapping the sheet material about the mandrel such that the sheet material folds at the fold lines and forms the elongate structure; and
a compressive member for releasably pressing at least the first outer side surface of the hollow outer portion of the elongate structure against the inner portion of the elongate structure after the sheet material has been wrapped about the mandrel; and
a controller operably associated with the motor and the compressive member, the controller being adapted to control rotation of the mandrel and pressure applied to the first outer side surface of the hollow outer portion.

2. The device according to claim 1, further comprising a tensioning member for selectively engaging the sheet material to provide rotational tension to the sheet material as the sheet material is wrapped around the mandrel, the tensioning member being disposed adjacent the mandrel radially opposite the compressive member.

3. The device according to claim 1, wherein the compressive member includes a first arm and a second arm, the first arm facing the second arm and cooperating with the second arm to define a V-shaped structure for contacting the first outer side surface and the second outer side surface of the elongate structure formed on the mandrel.

4. The device according to claim 2, further comprising a table having a working surface, said mandrel being operatively supported by the table in a cantilevered manner above the working surface, the table defining a tensioning member passageway through which the tensioning member can be selectively extended to engage with the sheet material as the sheet material is wrapped around the mandrel.

5. The device according to claim 5, wherein the mandrel is rotatably received in at least one pillow block and has a distal free end.

6. The device according to claim 5, further comprising an adhesive dispenser slidably connected to the table via a rail fixedly attached to the table, the adhesive dispenser including a beam supporting at least one nozzle.

7. The device according to claim 6, wherein the adhesive dispenser comprises at least a first nozzle and a second nozzle disposed on the beam, the first nozzle being disposed between the second nozzle and the rail, the first nozzle being in fluid communication with a first reservoir for containing a first adhesive and the second nozzle being in fluid communication with a second reservoir for containing for a second adhesive.

8. The device according to claim 7, further comprising a third nozzle and a fourth nozzle disposed on the beam between the first nozzle and the second nozzle, the third nozzle and the fourth nozzle being in fluid communication with the first reservoir.

9. The device according to claim 5, wherein the tensioning member is rotatably attached to the table and is adapted to rotate in a direction opposite to the rotation of the mandrel at a speed less than a rotating speed of the mandrel.

10. The device according to claim 1, wherein the mandrel and the gripper blade cooperate to define a sheet material slot adapted to receive a leading edge of the sheet material.

11. The device according to claim 2, wherein the mandrel has a hexagonal cross section defining six obtuse vertices, the six vertices being adapted to radially align with the fold lines of the sheet material that define the inner portion of the elongate structure.

12. The device according to claim 1, wherein the gripper blade and a sidewall of the mandrel are generally parallel to one another and cooperate to define a sheet material slot for receiving a leading edge of the sheet material.

13. An elongate structure, comprising:
a hollow outer portion formed of sheet material;
a hollow inner portion formed of sheet material; and
a U-shaped reinforcement portion formed of sheet material and disposed within the hollow inner portion;
wherein the hollow outer portion includes at least a first outer side surface that defines a first plane, a second outer side surface that defines a second plane, and a third outer side surface that defines a third plane,
wherein the first plane intersects with the second plane at a first dihedral angle, the second plane intersects with the third plane at a second dihedral angle, and third plane intersects with the first plane at a third dihedral angle,
wherein the sum of the first dihedral angle, the second dihedral angle and the third dihedral angle is about 180°,
wherein the hollow inner portion is disposed within the hollow outer portion,
wherein the hollow inner portion contacts a first inner side of the hollow outer portion opposite the first outer side surface, a second inner side of the hollow outer portion opposite the second outer side surface, and a third inner side of the hollow outer portion opposite the third outer side surface, and
wherein the hollow inner portion includes at least a first panel that extends between the first inner side of the hollow outer portion and the second inner side of the hollow outer portion so as to define a first hollow inner triangular channel, and a second panel that extends between the second inner side of the hollow outer portion and the third inner side of the hollow outer portion so as to define a second hollow inner triangular channel.

14. A pallet, comprising a plurality of pallet runners formed by elongate structures according to claim 13 joined to a deck.

15. The pallet of claim 14, wherein the plurality of elongate structures are parallel to one another and are joined to a same side of the deck.

16. A method for manufacturing an elongate structure, the method comprising:
providing a substantially flat piece of sheet material provided with a plurality of creases that define fold lines;
contacting a leading edge portion of the sheet material to a mandrel;
rotating the mandrel in a first direction at a first rotational speed to fold the sheet material on the fold lines so as to form the elongate structure, said elongate structure including a hollow outer portion and a hollow inner portion disposed within the hollow outer portion, wherein the hollow outer portion includes at least a first outer side surface that defines a first plane, a second outer side surface that defines a second plane, and a third outer side surface that defines a third plane, wherein the first plane intersects with the second plane at a first dihedral angle, the second plane intersects with the third plane at a second dihedral angle, and third plane intersects with the first plane at a third dihedral angle, wherein the sum of the first dihedral angle, the second dihedral angle and the third dihedral angle is about 180°, wherein the hollow inner portion contacts a first inner side of the hollow outer portion opposite the first outer side surface, a second inner side of the hollow outer portion opposite the second outer side surface, and a third inner side of the hollow outer portion opposite the third outer side surface, and wherein the hollow inner portion includes at least a first panel that extends between the first inner side of the hollow outer portion and the second inner side of the hollow outer portion so as to define a first hollow inner triangular channel, and a second panel that extends between the second inner side of the hollow outer portion and the third inner side of the hollow outer portion so as to define a second hollow inner triangular channel; and
compressing the first outer side surface of the elongate structure against the hollow inner portion using a compressive member while the elongate structure is on the mandrel.

17. The method according to claim 16, further comprising:
rotationally tensioning the sheet material with a tensioning member as the sheet material is wound around the mandrel, said tensioning member rotating a second direction at a second rotational speed, the second direction being opposite the first direction and the second rotational speed being slower than the first rotational speed.

18. The method according to claim 16, further comprising:
applying a first adhesive to the sheet material; and
applying a second adhesive to the sheet material;
wherein the first adhesive is applied to an area of the sheet material between the leading edge and the second adhesive, wherein the second adhesive has a set time that is less than a set time of the first adhesive.

19. The method according to claim 16, wherein the mandrel includes a gripper blade and the leading edge of the sheet material contacts the gripper blade.

20. The method according to claim 16, wherein the leading edge of the sheet material is retained to the mandrel by vacuum pressure.
